(19) United States
(12) Patent Application Publication
(10) Pub. No.: US 2007/0073568 A1
(43) Pub. Date: Mar. 29, 2007

(54) Method and apparatus to predict activity

(76) Inventor: Hideki Kobayashi, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/389,067

(22) Filed: Mar. 27, 2006

(30) Foreign Application Priority Data
Sep. 28, 2005 (JP) 2005-281656

(51) Int. Cl. G06F 17/30

(52) U.S. Cl. 705/8; 705/10

(57) ABSTRACT

An activity prediction method includes reading activity statistics data of an object group of people from a database storing activity statistic data made by consolidating activity patterns of people, and modifying the readout activity statistics data according to the object group to obtain activity occurrence provability of the object group.

### CROSS-REFERENCE TO RELATED APPLICATIONS

This application is based upon and claims the benefit of priority from prior Japanese Patent Application No. 2005-281656, filed Sep. 28, 2005, the entire contents of which are incorporated herein by reference.

### BACKGROUND OF THE INVENTION

1. Field of the Invention

The present invention relates to an activity prediction method for predicting the occurrence rate of activities of an object group by utilizing activity statistics, which is made by consolidating activity patterns, and by modifying such activity statistics in accordance with constraint information on place, and an activity prediction apparatus therefor.

2. Description of the Related Art

It has become an assignment for the whole society to address environmental issues, such as global warming. With that, in order to reduce environmental load of products and services, various technological developments have taken place to provide environmentally-friendly products and services to the market. Improvement on time efficiency is cited as one of the various measures to reduce the environmental load of products/services. Improvement on time efficiency means to reduce time required per unit of functionality provided by the products/services.

If time required for achieving a desired purpose is reduced, chance of reducing consumption energy secondarily is high due to shortened operating time of the product/service. However, on the other hand, if a lot of energy is consumed by performing other activities in the saved time, energy consumption may become higher than before the introduction of the new product/service in comparison within the same given time. Such side effect is called a rebound effect. For example, “As a result of e-commerce, chances to travel have increased due to derived leisure time”, would be an example of such rebound effect. In the future, in order to control the total amount of environmental load that is generated in the whole society, it is necessary to evaluate not only the environmental load resulting from the product/service itself as in the past, but also the environmental load including the rebound effect.

Correspondingly, a method for predicting the degree of environmental load generated from an object group during the saved time is devised. In Mikko Jalas, A Time Use Perspective on the Materials Intensity of Consumption, Ecological Economics 41 (2002) 109-123., energy consumption generated during the saved time is calculated by using the average energy consumed by the nation in their nonbinding hours. Further, in Kazue Takahashi, et. Al. Environmental Impact of Information and Communication Technologies Including Rebound Effects, Proc. of the Int. Symp. on Electronics and the Environment, IEEE, (2004-5) 13-16, a questionnaire is conducted for an object group in order to examine what activities they perform in the saved time developed by the service. Based on the survey results, factors of environmental load generated by each activity are determined in order to estimate the environmental load generated as a whole.

In the method of Mikko Jalas, as the attribute and circumstances of the object group are disregarded, the estimation would inevitably turn out quite rough. Further, although the method of Kazue Takahashi, et. is deemed to give precise estimation in that being considered on an exclusive target group and that being restricted to the saved time generated by a certain service, it may be quite labor-some to carry out a questionnaire every time on each occasion. Furthermore, it is basically doubtful whether the object group will behave in accordance with the response to the questionnaire. Thus, the conventional arts prove insufficient to predict activities of an object group involved in the improvement of time efficiency.

### BRIEF SUMMARY OF THE INVENTION

It is an object of the present invention to provide a method for predicting activities of an object group by utilizing behavioral statistics, which consolidate activity patterns of a person, and by altering such behavioral statistics by using constrained condition of places, and an apparatus therefor.

An aspect of the present invention provides an activity prediction method comprising reading activity statistics data of an object group of people from a database storing activity statistic data made by consolidating activity patterns of people; and modifying the readout activity statistics data according to the object group to obtain activity occurrence provability of the object group.

### BRIEF DESCRIPTION OF THE SEVERAL VIEWS OF THE DRAWING

FIG. 1 illustrates an activity prediction method according to a first embodiment of the present invention.

FIG. 2 shows an activity rate graph according to behavioral statistics of primary, secondary and tertiary activities carried out by adult women on weekdays.

FIG. 3 illustrates probabilities of the primary, secondary and tertiary activities taking place.

FIG. 4 illustrates particulars of each activity specified in FIG. 3.

FIG. 5 is a flow chart showing modification procedures of an activity occurrence probability.

FIG. 6 illustrates place constraint relation.

FIG. 7 illustrates consumption expenditure data classified in terms of group attribute.

FIG. 8 is a graph chart showing statistics of required expenses per conduct of activity.

FIG. 9 shows the statistics of required expenses per conduct of activity given in FIG. 8 in a form of a chart.

FIG. 10 illustrates activity occurrence probabilities before and after modification.

FIG. 11 illustrates an occurrence probability after the modification of the tertiary activity particulars.

FIG. 12 is a flow chart showing a process to allocate activities to saved time.

FIG. 13 illustrates statistics of an average required time per conduct of activity.

FIG. 14 is a bar chart showing a portion of an activity allocation result.

FIG. 15 illustrates a portion of statistics in environmental load unit consumption.

FIG. 16 illustrates a portion of environmental load calculation results.

FIG. 17 is a block diagram of an activity prediction apparatus to carry out an activity prediction method.

FIG. 18 illustrates an activity prediction method of a second embodiment according to the present invention.

FIG. 19 is a flow chart showing other procedures to alter an activity occurrence probability.

### DETAILED DESCRIPTION OF THE INVENTION

Embodiments of the present invention will be explained in detail in reference to the drawings.

### First Embodiment

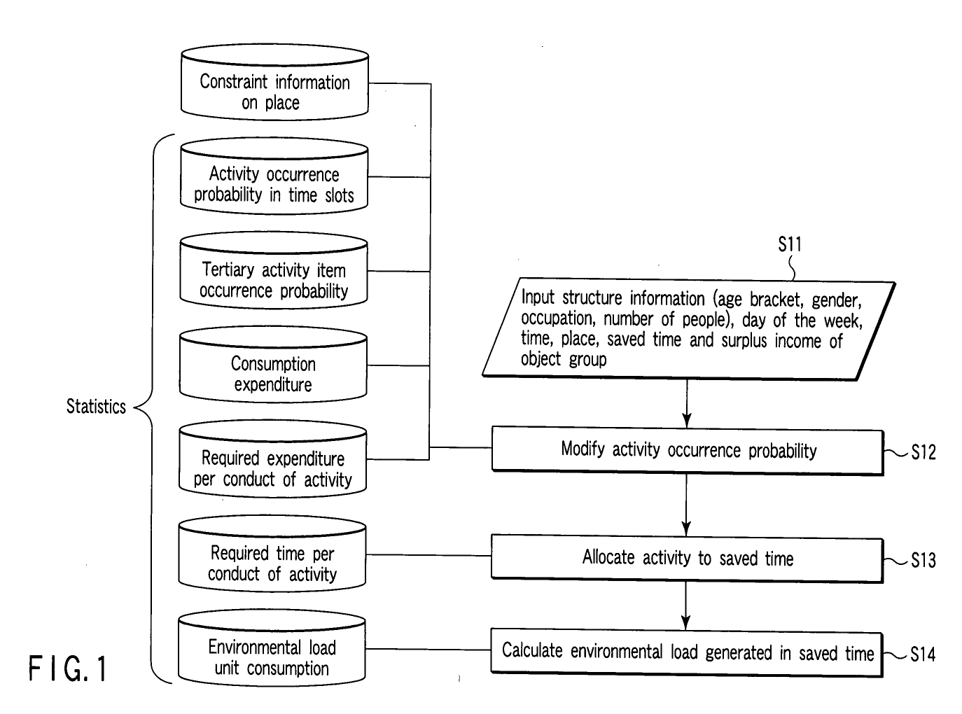

FIG. 1 is a diagram for explaining an activity prediction method of a first embodiment according to the present invention. According to this, structure information of an object group (age bracket, gender, occupation and head-count), day of the week, time, place, saved time and surplus income is input in input process S11. In modification process S12, an activity occurrence probability data (activity occurrence probability data in time slots, tertiary activity particulars occurrence probability data) in statistics is modified in accordance with constraint on place and consumption expenditure (consumption expenditure, expenses required per conduct of activity). In allocation process S13, activities are allocated to the saved time based on information of the computed activity occurrence probability. In the final environmental load calculation process S14, an environmental load generated within the saved time is calculated by using an environmental load unit consumption (per time, per amount) of the allocated activity.

The present embodiment will be explained below based on specific examples. Here, assumed that an object group of 100 female system engineers in their thirties are participating in e-learning on weekdays. The e-learning is assumed to take place at their homes and ends at 15:00, which gives two hours of saved time. The value of saved time is calculated by comparing the case to learning in facilities. Further, surplus income is deemed not to increase by e-learning. In such case, activities of the object group can be classified as follows:

1. Primary Activity (Physiologically Required Activities)

Sleeping, Personal needs, Meals

2. Secondary Activity (Mandatory Activities)

Commuting to office or school, Work, Schoolwork, Household chores, Caring/Nursing, Raising children, Shopping

3. Tertiary Activity (Activities Regarded as Leisure Activity)

Traveling (excluding commuting to office and school), television/radio/newspaper/magazine, resting/relaxing, learning/researching (excluding schoolwork), hobby/entertainment, sports, volunteer activities/social participation activities, socialization/association, medical checkup/medical treatment, etc.

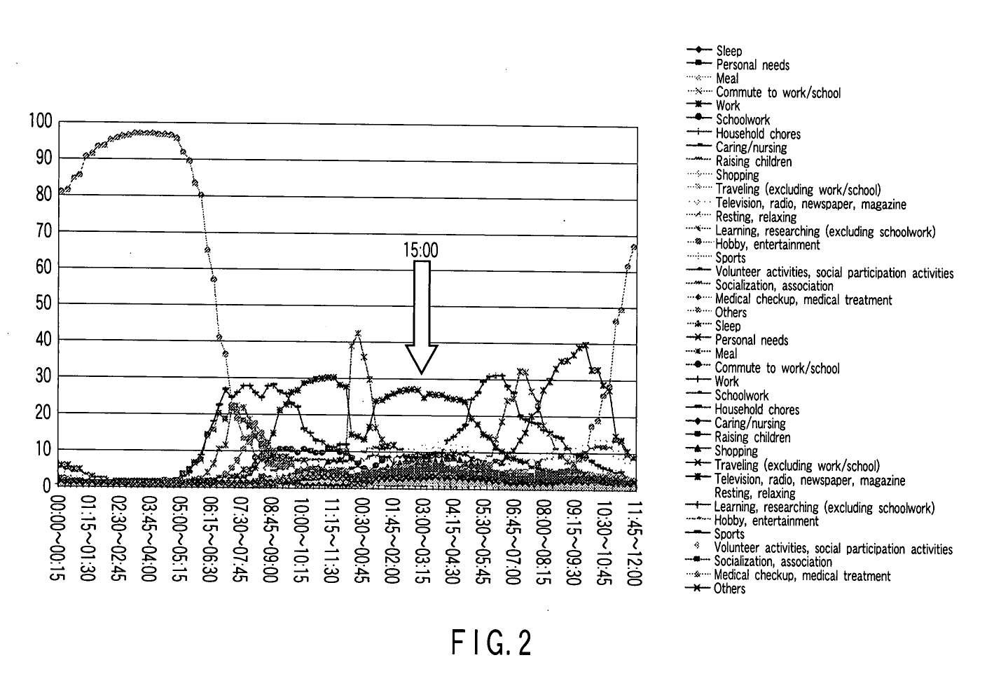

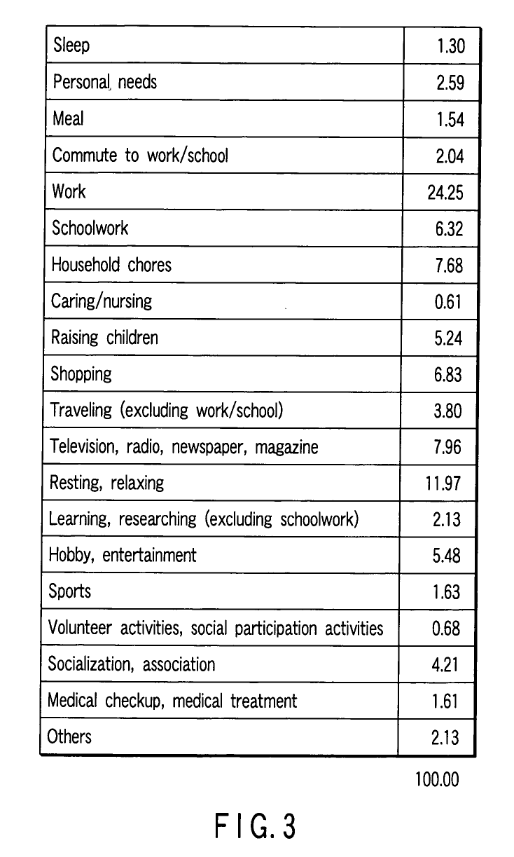

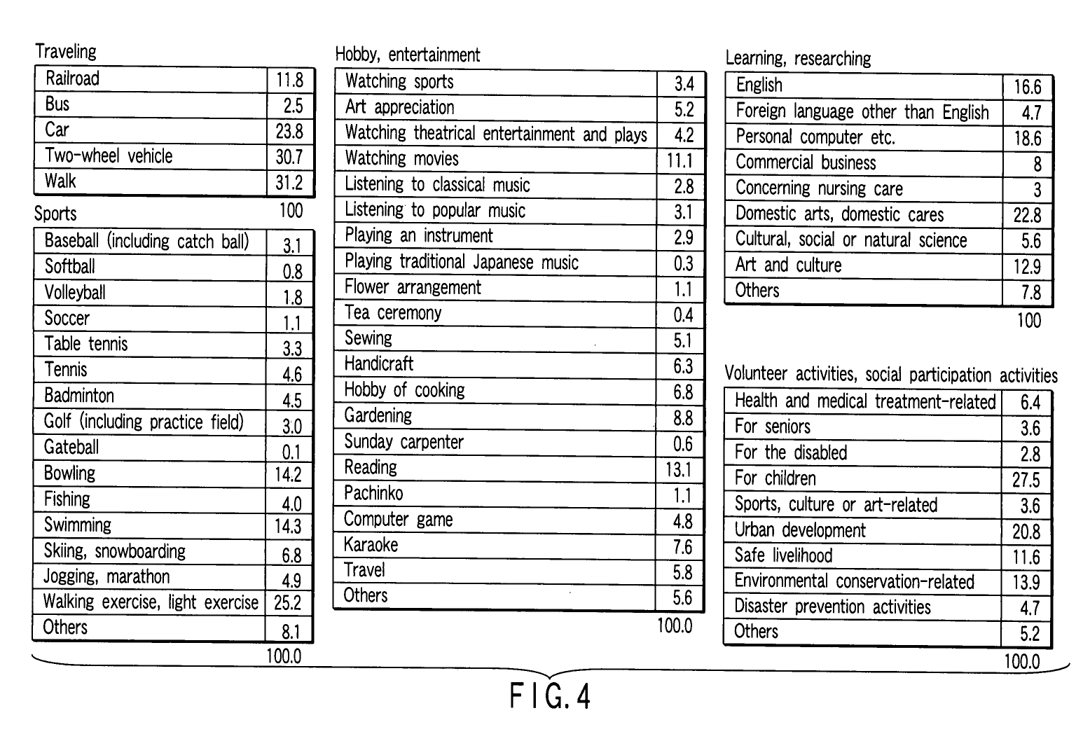

FIG. 2 is an activity rate graph based on the activity statistics of primary, secondary and tertiary activities of adult women on weekdays. More specifically, the activity rate graph shows the time slot on the lateral axis and the activity rate on the vertical axis. This graph contains various activities shown in the table on the right side. By extracting the adult women's activity carried out at 15:00, occurrence probabilities of the primary, secondary and tertiary activities can be obtained as shown in FIG. 3. Particulars of each activity in FIG. 3 are shown in FIG. 4. The occurrence probability of the activity in FIG. 3, such as traveling, is shown respectively in terms of railroad, bus, car, two-wheel vehicle and walk in FIG. 4. Similarly, occurrence probabilities regarding particulars of sports, hobby/entertainment, learning/researching and volunteer activities/social participation activities are shown. Each occurrence probability is granted to each activity so that its total meets 100%.

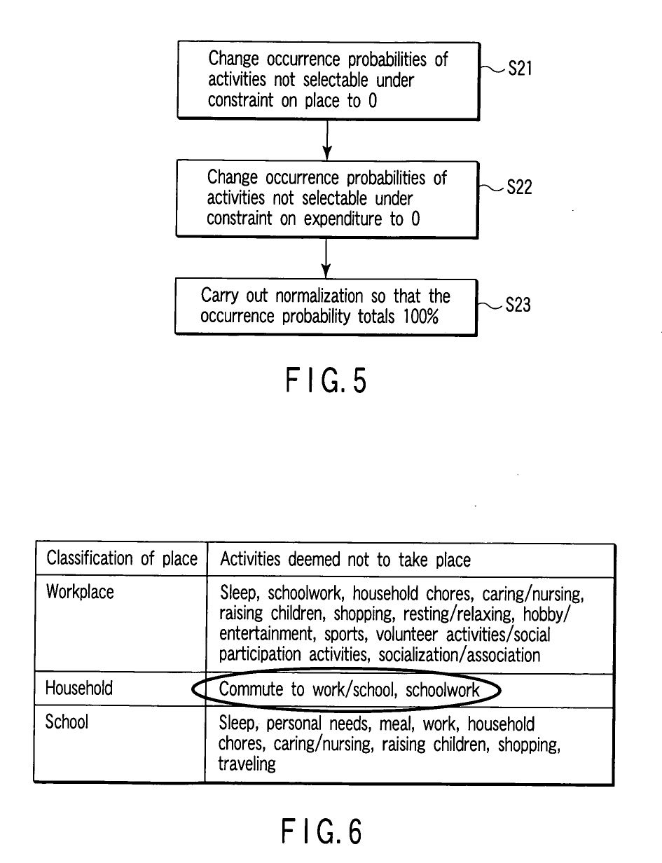

These activity statistics are modified in the procedure shown in FIG. 5 in compliance with an assessed scenario. Firstly, occurrence probabilities of activities which cannot be selected due to constraint on place, such as “Commuting to office or school” and “Schoolwork”, are changed to 0 (S21). That is to say, as the object group is restricted to the place of households, activities such as “Commuting to office or school” and “Schoolwork” shown in FIG. 6 are disregarded for having significantly very low occurrence probability. Next, occurrence probabilities of activities which cannot be selected due to restrictions on expenditures are changed to 0 (S22). This will be explained later on. Subsequently, occurrence probabilities are normalized so that the total meets 100% (S23). Here, firstly, normalization regarding constraint on place is carried out. That is to say, the original occurrence probability, which is changed to 0, i.e., the occurrence probabilities of 2.04 for “Commuting to office or school” and 6.32 for “Schoolwork”, which total 8.36, are divided among the other activities so that the occurrence probabilities of remaining activities total 100%.

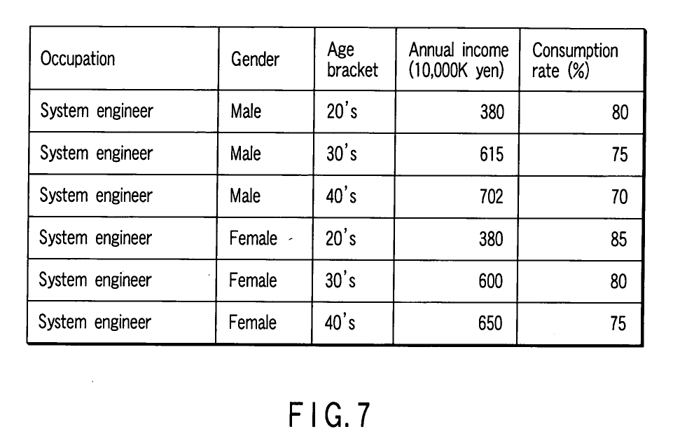

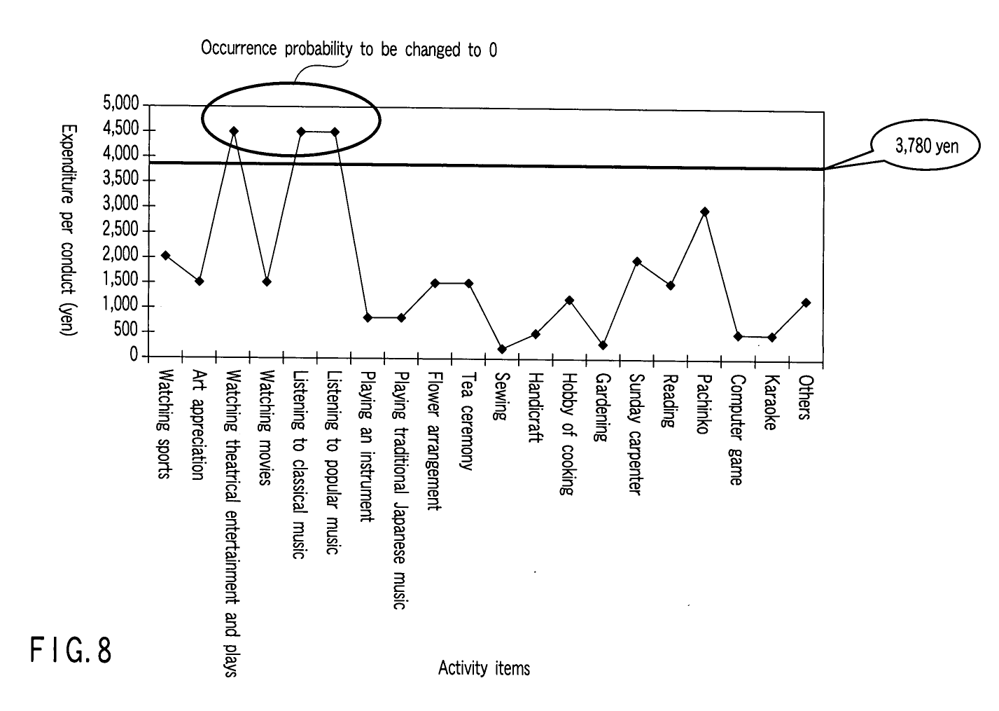

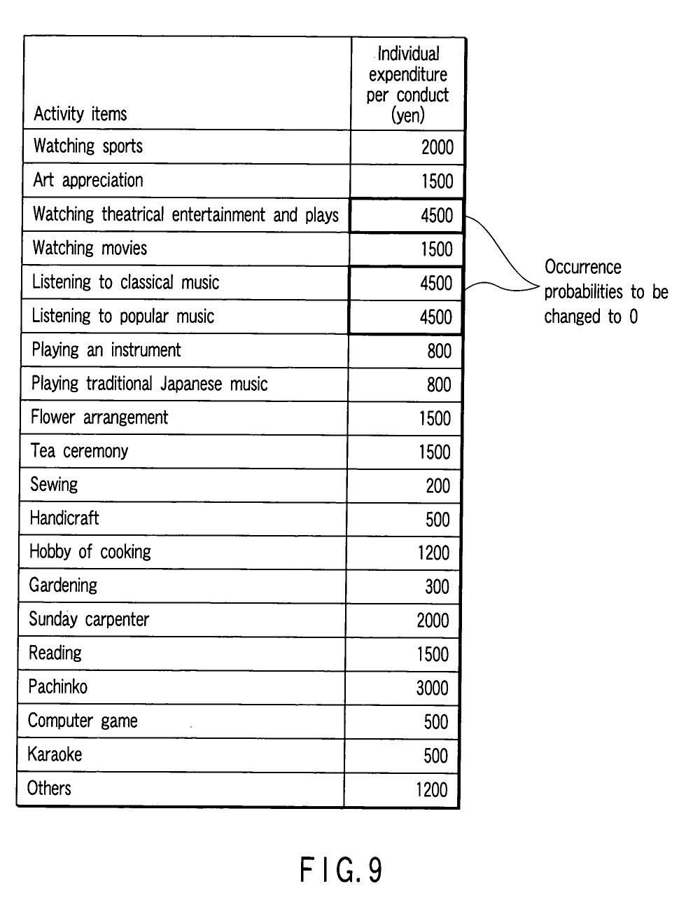

Next, constraint on expenditure is explained. FIG. 7 shows statistics regarding annual income and consumption rate in the case of an occupation of a system engineer. The consumption rate stands for the percentage of the amount of consumption expenditure against the annual income. For example, in the case of a female system engineer in her thirties, average consumption expenditure per day can be worked out as; annual income 6,000,000 yen×80% consumption rate/365 days=13,500 yen/day. Here, given that 80% of the entire consumption expenditure is consumed on Saturdays and Sundays, the average consumption expenditure per day on weekdays can be calculated as; 13,500×7×0.2/5=3,780 yen. When using the 3,780 yen as a constrained condition for expenditure, for example, as shown in FIG. 8, the hobby and entertainment activities exceeding 3,780 yen will be considered as not being carried out. Accordingly, as shown in FIG. 9, occurrence probabilities of activities that exceed the amount of 3,780 yen, i.e., “theatrical entertainment and plays”, “listening to classical music”, and “listening to popular music”, are changed to 0. After modification, normalization regarding the constraint on expenditure is carried out likewise the constraint on place.

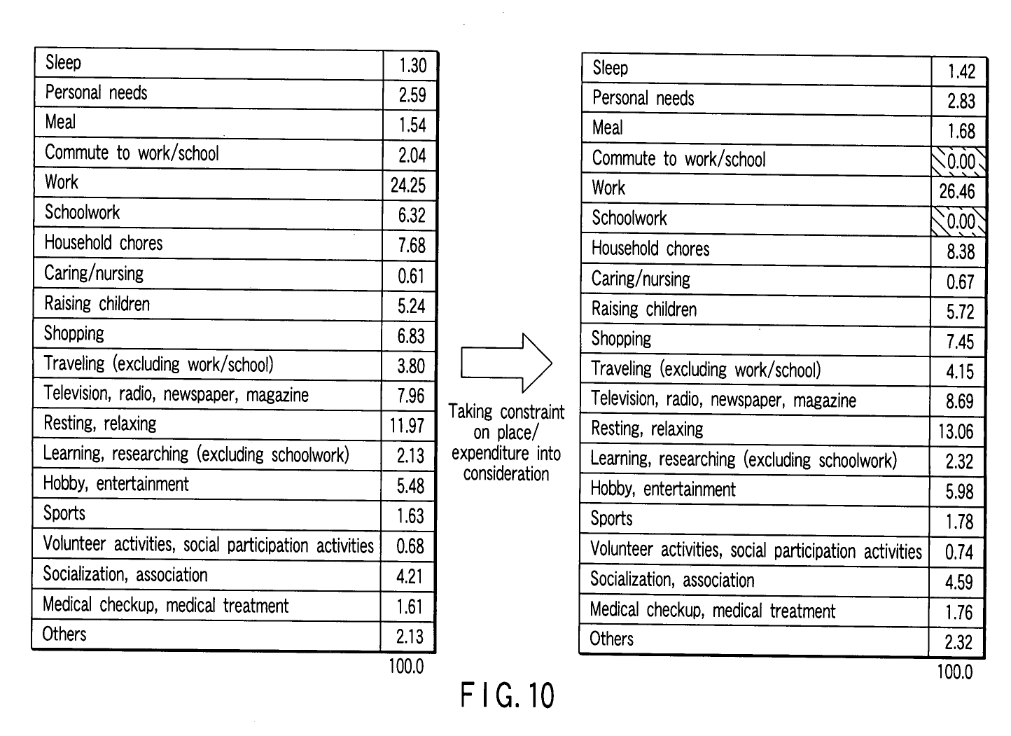

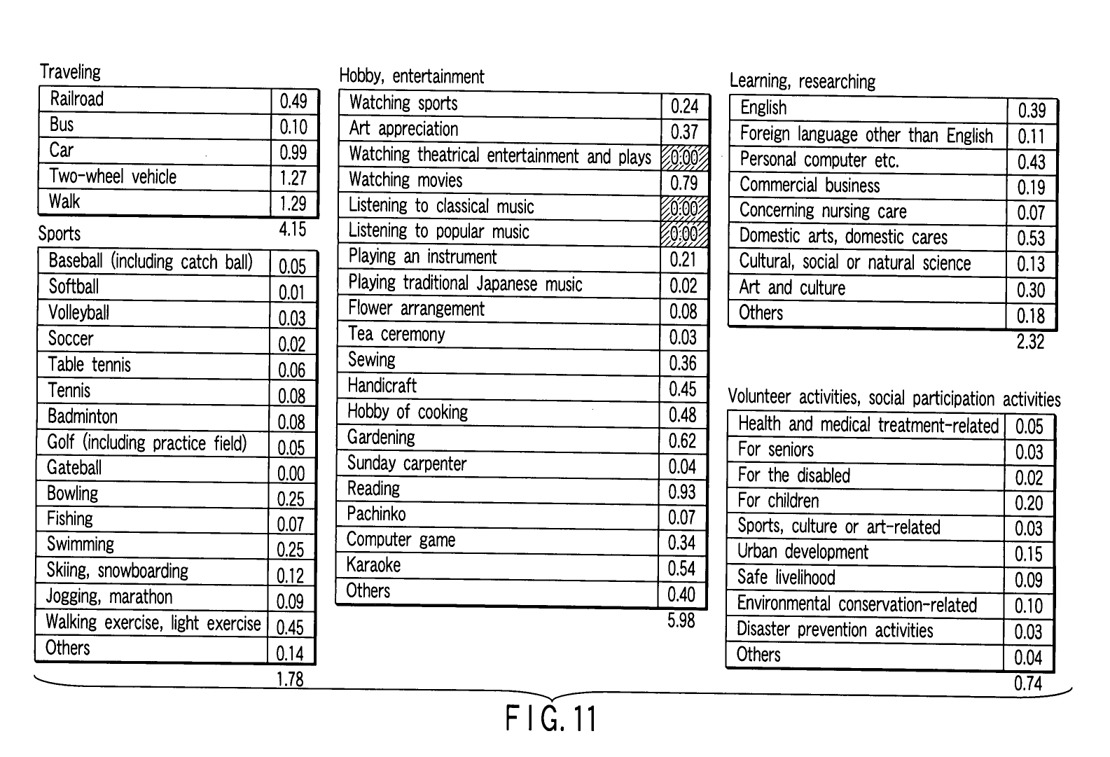

FIGS. 10 and 11 show examples of reflecting both the constraint on place and expenditure and further normalizing the occurrence probability so that the total value meets 100%. More specifically, “Commuting to office or school” and “Schoolwork” in FIG. 10 and “theatrical entertainment and plays”, “listening to classical music”, and “listening to popular music” in FIG. 11 are changed to 0 and normalized. With this, initial activity statistics are interpreted as being modified to apply to a female system engineer in her thirties. By working out the activity occurrence probability as explained above, saved time, which, in the present embodiment, is the two hours between 3:00 to 5:00, is allocated to activity. In the present embodiment, as the object group is fixed as 100 people, a method to carry out allocation by the entire group is adopted. Since there is two hours of saved time per capita, there will be 200 hours of saved time for the entire 100 people. Activities are allocated to such 200 hours.

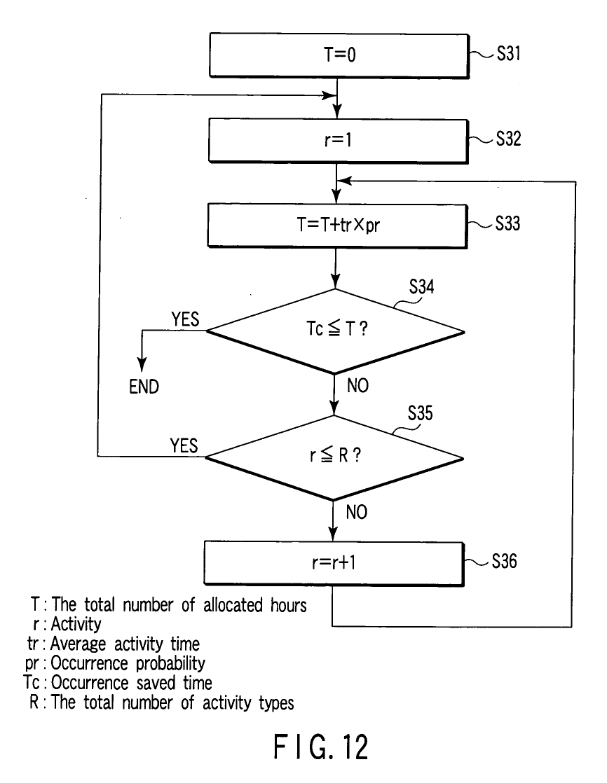

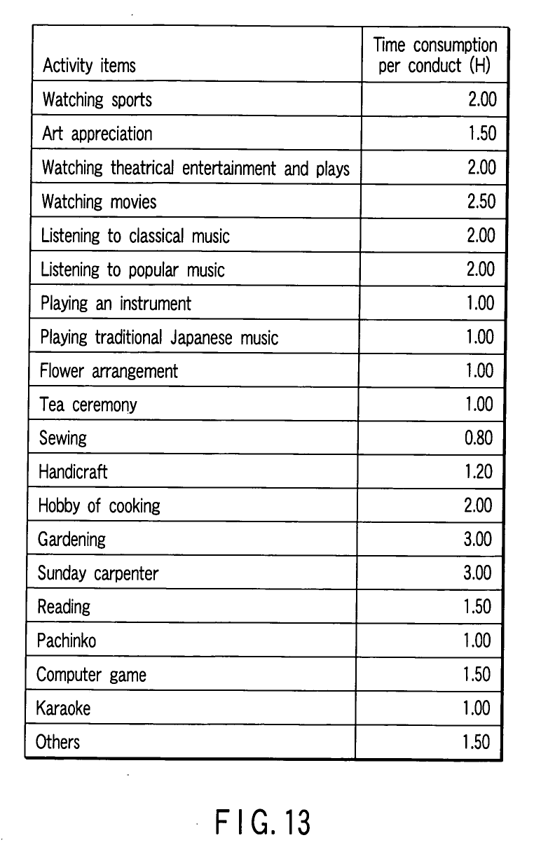

The flow chart in FIG. 12 illustrates the above allocation procedure. According to this, first, saved time is computed by, for example, multiplying two hours by the head-count of the group, say 100 people, in order to work out an occurrence saved time Tc (200 hours) of the entire group. Then, an anticipated activity time is allocated in descending order of activities with high occurrence probability. In such case, at the beginning, the total number of allocated hours T is set to 0 (S31). Next, activity r is set to 1 (S32). Here, r (=1, . . . , R) is represents an activity that is sorted in descending order of occurrence probability. Subsequently, the product of average activity time tr of activity r and occurrence probability pr of activity r, i.e., anticipated activity time of activity r, is added to the total number of hours T, thereby updating the total number of hours T (S33). The total number of allocated hours T and the occurrence saved time Tc are compared (S34), and anticipated activity time is allocated in sequence until the total number of allocated hours T≧occurrence saved time Tc is obtained. In other words, if r=R is not obtained when comparing the activity r with the total number of activity types R(S35), the activity r is updated (S36), and the process goes back to step S33. If T exceeds Tc, fractions are rounded in order to obtain T=Tc, and the process is terminated. As an example of tr, FIG. 13 shows an example of an average required time of a woman in her thirties to perform each conduct of hobby and entertainment activities.

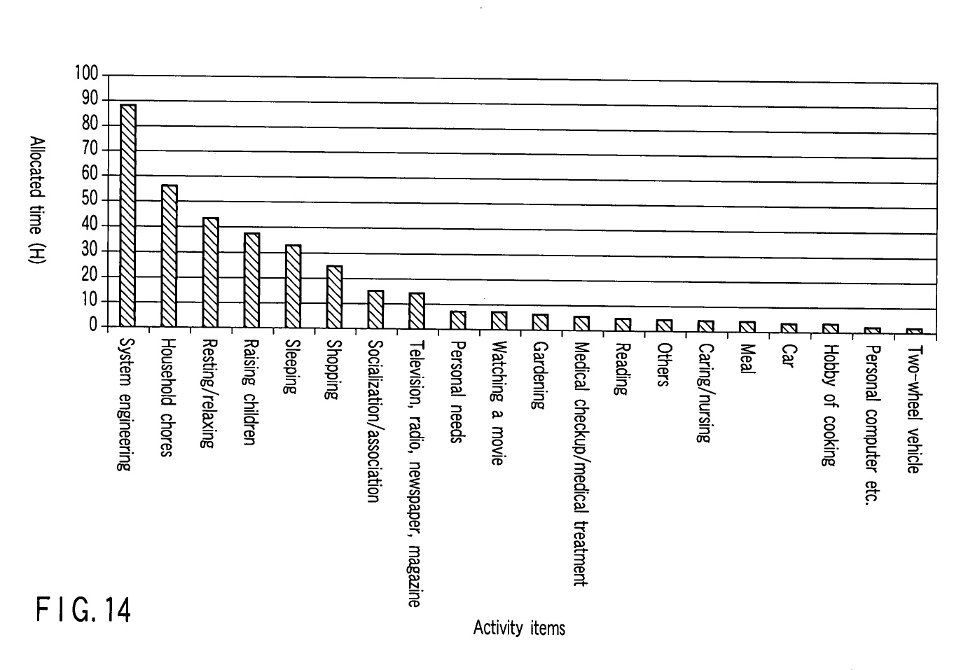

Thus allocated activity time is added up with respect to each activity, and the top 20 activities with large allocated activity time are shown in FIG. 14. The present example indicates that the largest number of people spend the saved time after e-learning renewedly for their jobs (system engineering). However, it also indicates that some people choose shopping, socialization/association or traveling by car etc. subsequent to the choice of job.

By allocating time in the foregoing manner, the environmental load generated within the 200 hours can be calculated from a carbon dioxide occurrence rate for each activity on condition that a database of environmental load per hour of each activity is readied in advance. Although the final purpose is to determine this environmental load, the most important issue during the process of achievement is to output the activities and the time on which the object group can spend. When attempting to allocate two hours for one person, the activities that can be chosen in the two hours are much limited. As the number of people in a group increases, the activity of an individual diversifies, and the choice of activity increases. Accordingly, the result obtained by the present invention reflects the fact that selective activities diversify as the scale of a group increases. The relation between data of activity time and the environmental load is explained in detail as follows.

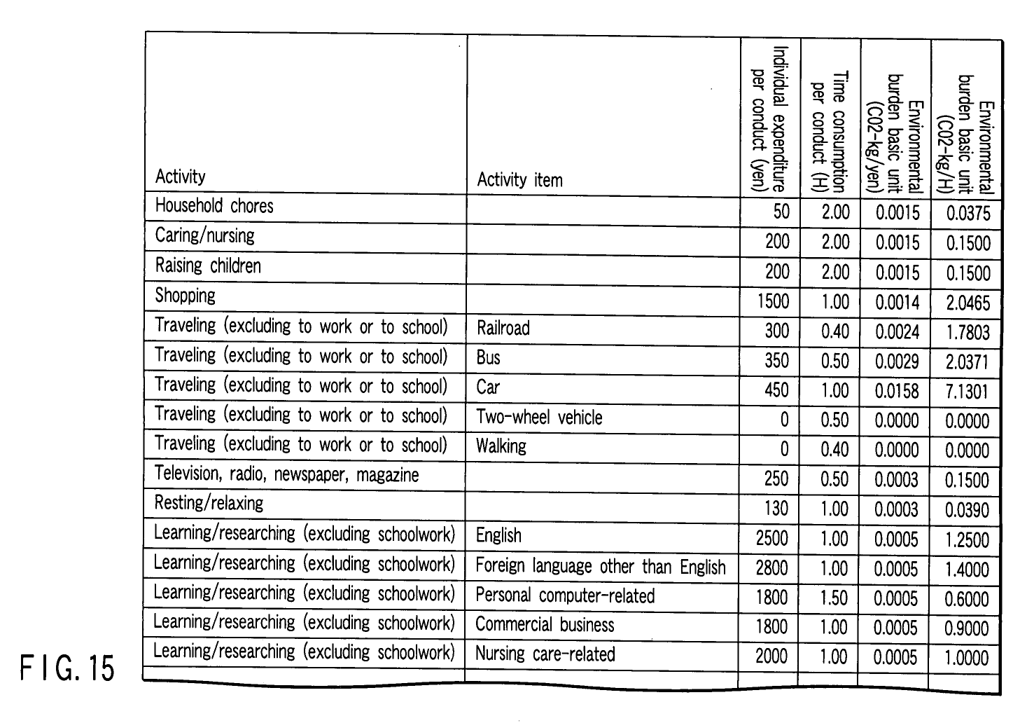

FIG. 15 shows a portion of statistics with respect to environmental load unit consumption of carbon dioxide emission ejected by activity per expenditure and time. According to this, by using the data of average activity time (time consumption per conduct of activity (H)) and average expenditure (individual expenditure per conduct of activity (yen)) the environmental load unit consumption per amount of expenditure (CO₂-kg/yen) is converted into the environmental load unit consumption per time (CO₂-kg/H).

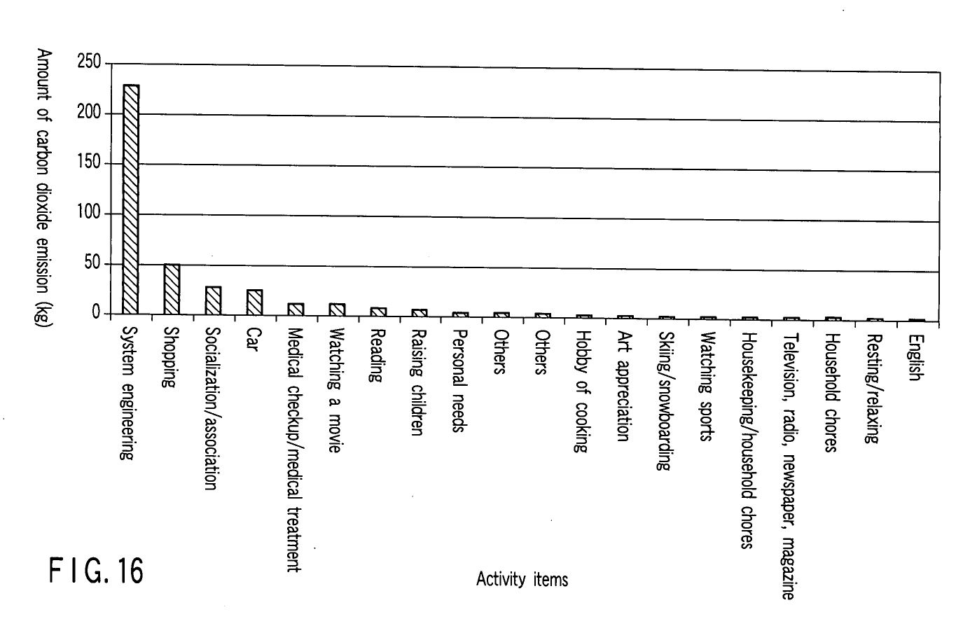

FIG. 16 shows a portion of the environmental load calculation result, i.e., the portion of the environmental load calculation result regarding the environmental load (the total of 417CO₂-kg) for the top 20 activities of environmental load. According to this, a predicted value of environmental load calculated by multiplying the estimated activity time by the environmental load unit consumption per time is indicated. The present result shows a predicted value of the carbon dioxide emission generated by the relevant target group during the saved time from 15:00 to 17:00 on weekdays as a result of e-learning. The present example also shows that a large environmental load occurs by working continuously. Meanwhile, the comparison of FIG. 14 with FIG. 16 shows that activities with longer allocated activity time do not necessarily discharge a large amount of environmental load. This is because of the difference in the environmental load unit consumption.

In this manner, by adding the attribute and place information of the object group into consideration, the total amount of environmental load generated by the saved time and its breakdown can be predicted by the present invention. The impact on the environmental load increases as the group scale increases.

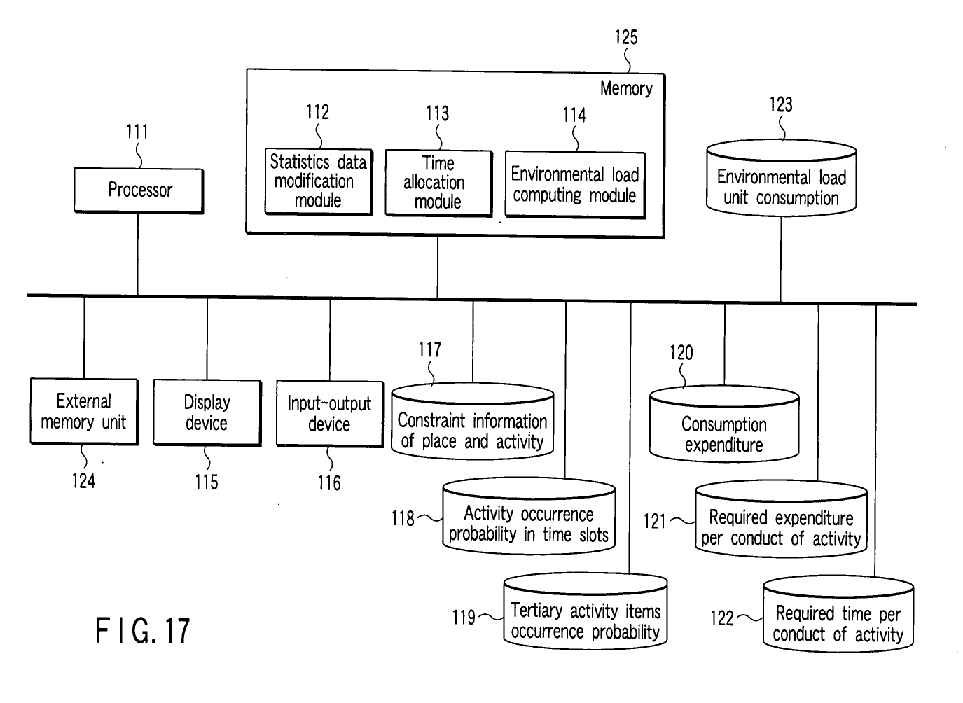

FIG. 17 shows hardware for carrying out the activity prediction procedure, i.e. an activity prediction apparatus of the above embodiment. The present apparatus is provided with a processor (CPU) 111, statistics modification module 112, a time allocation module 113, an environmental load computing module 114, a display device 115, an input-output device 116, various databases, i.e., a database 117 for constraint information of place and activity, a database 118 for activity occurrence probability in time slots, a database 119 for tertiary activity items occurrence probability, a consumption expenditure database 120, a database 121 for required time expenditure per conduct of activity, a database 122 for required time per conduct of activity and an environmental load unit consumption database 123 as well as an external memory unit 124.

The statistics data modification module 112, time allocation module 113 and environmental load computing module 114 correspond to a program stored in a memory 125. By carrying out the program loaded to the memory 125 by the external memory unit 124, the processor 111 conducts various control process of necessity including the input-output control and various computation processes.

In the system of FIG. 17, suppose the user sets the subject of survey to 100 female system engineers in their thirties, the user inputs conditions such as age group, gender, occupation, number of people, day of the week, time, place, saved time, surplus income etc. by the input-output device 116. When the conditions are input, an activity occurrence probability is read out from the database 118 for activity occurrence probability in time slots and database 119 for tertiary activity items occurrence probability, and further loads each data from the database 117 for constraint information of place and activity, consumption expenditure database 120, database 121 for required time expenditure per conduct of activity and database 122 for required time per conduct of activity. Processor 111 modifies the activity occurrence probability in accordance with the program stored in the statistics modification module 112, time allocation module 113 and the environmental load computation module 114, according to the procedure explained in reference to FIGS. 1 to 13.

The result obtained by the above modification process can be utilized to estimate environmental load and the like. In other words, it can be used to estimate how much environmental load will occur within a certain group. Further, the modification process result can be displayed on the display device 115 or printed out by the input-output device 116.

By carrying out a service that will allow the object group to change from learning at facilities to e-learning as mentioned above, two hours of saved time can be generated, in accordance with which the environmental load is estimated to decrease. Obviously, if an activity, which generates high environmental load, is carried out instead in this saved time, the environmental load may rather increase. In such a case, the time slots of the service to be modified may be shifted or the service may be modified to another one.

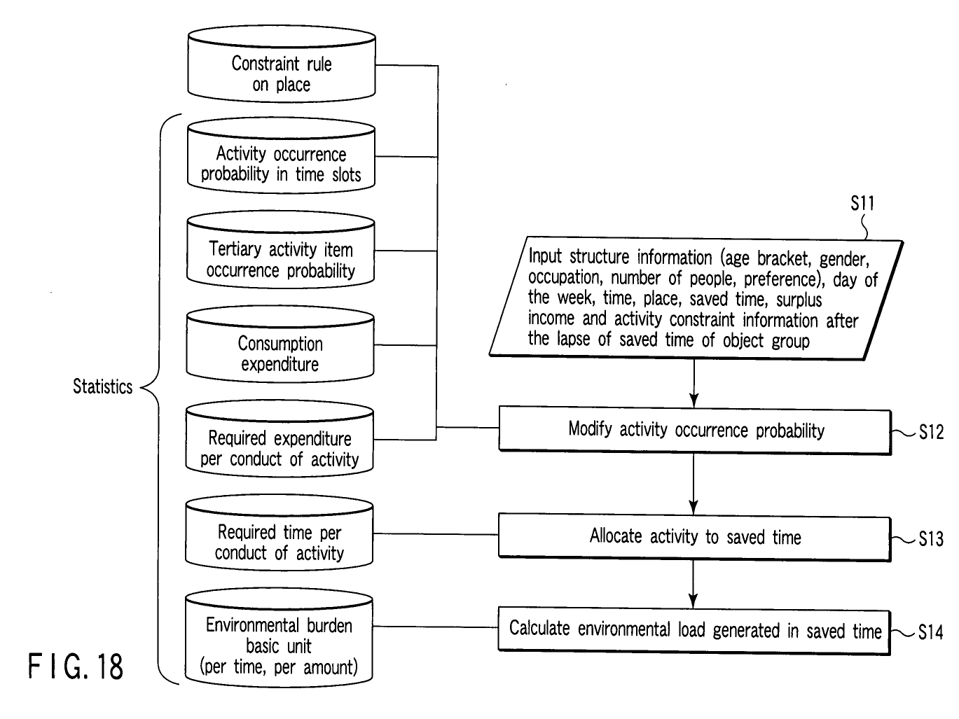

For example, FIG. 18 shows an embodiment enabling a much precise estimation by carrying out activity allocation by adding information related to preference of the object group and condition of constraint after elapse of the saved time (such as condition of constraint to be at home by 17:00) into consideration. As in the present embodiment, by adding a variety of information on preference, such as fond of shopping or fond of volunteering, the activity occurrence probability can be altered much precisely.

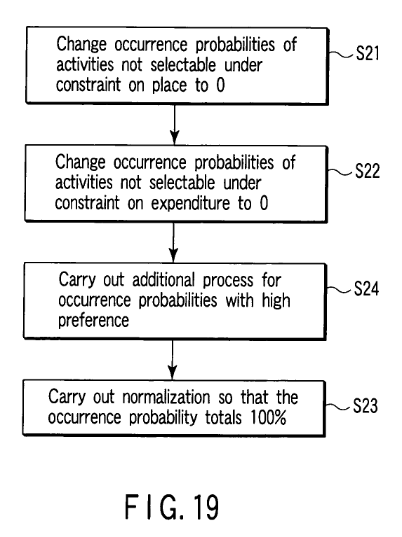

The differences between the first embodiment and the second embodiment are whether the preference is taken into consideration or not and whether a condition of constraint exists after the lapse of the saved time or not. For example, in the modification tables of FIGS. 10 and 11, items having low probability are set to 0. However, for example, if the person is fond of shopping, modification may be carried out in accordance with a predetermined rule, such as increasing the occurrence probability of shopping 10% (S24) as shown in FIG. 19. If there is information on constraint of activity after the lapse of saved time, such as in spite of being free until 5:00 p.m., the person must be at home by 5:00 p.m. or should arrive at another place by 5:00 p.m., such information may also be added. For example, if the person must arrive at another place by 5:00 p.m., the occurrence probability related to traveling will increase.

As explained above, in the present invention, when the object group is given a saved time anew, predictions are carried out on how the relevant group will behave in compliance with its attribute and circumstances. In other words, by adding the attribute and circumstances of the object group into consideration, activities of the object group are predicted with respect to what activities they will carry out during the saved time occurred as a result of improved time efficiency.

According to the present invention, activities can be predicted by adding the attribute and circumstances of an object group in consideration. By combining the prediction result and environmental load data, environmental load generated in a saved time can also be estimated. Accordingly, a rebound effect generated by a new product or new service can be estimated automatically without depending on a field of particular product/service, but with fair accuracy and independent of questionnaires.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An activity prediction method comprising:
reading activity statistics data of an object group of people from a database storing activity statistic data made by consolidating activity patterns of people; and
modifying the readout activity statistics data according to the object group to obtain activity occurrence provability of the object group.

2. The method according to claim 1, wherein the modifying includes modifying the readout activity statistic data according to constrained condition of place which is keyed in according to the object group.

3. The method according to claim 1, which further comprises reading out consumption expenditure data of the object group from a consumption expenditure database, and wherein the modifying includes modifying the activity statistic using the consumption expenditure.

4. The method according to claim 1, wherein the modifying includes modifying the activity statistic by using preference data of the object group.

5. The method according to claim 1, further comprising calculating a total of saved times for number of people in the group which are acquired by modifying activities of the object group, and allocating the total of saved times to the activities in accordance with the activity occurrence probability.

6. The method according to claim 5, wherein the allocating includes allocating an average activity time per capita to each of the activities in accordance with the activity occurrence probability until reaching the total of saved times.

7. An activity prediction method according to claim 1, wherein the modifying includes setting an occurrence probability of activities unselected by the object group to 0 and normalizing an occurrence probability of activities remaining after modification.

8. An activity prediction method according to claim 1, wherein the modifying includes modifying at least one item of the activities of the object group.

9. An activity prediction method comprising:
reading out activity statistic data of an object group of people from a database storing activity statistics data made by consolidating activity patterns of people;
modifying the readout activity statistic data according to constrained condition of consumption expenditure which is keyed in according to the object group to obtain an activity occurrence probability of the object group.

10. An activity prediction method comprising:
reading out activity statistic data of an object group of people from a database storing activity statistics data made by consolidating activity patterns of people; and
modifying the readout activity statistic data according to constrained condition of preference which is keyed in according to the object group.

11. An activity prediction apparatus comprising:
a database to store activity statistics data obtained by consolidating activity patterns of people; and
a processor to read out activity statistics data of an object group of people from the database to obtain an activity occurrence probability of the object group and modify the readout activity statistics data in accordance with a key input constrained condition of place.

12. The apparatus according to claim 11, wherein the process or modifies the activity statistics data regarding the object group by using consumption expenditure data of the object group.

13. The apparatus according to claim 11, wherein the processor calculates a total of saved times of number of people in the object group, which are generated by modifying the activities of the object group, and the total of saved times is allocated to the activities according to the activity occurrence probability.

14. The apparatus according to claim 13, wherein the processor allocates an average activity time per capita to the activities in accordance with the activity occurrence probability until reaching the total of saved times of the number of people in the group.

15. The apparatus according to claim 11, wherein the processor sets occurrence probabilities of activities unselected by the object group to 0 and normalizes occurrence probabilities of activities remaining after modification.

16. The apparatus according to claim 11, wherein the processor modifies at least one item of activities of the object group.

17. An activity prediction program stored in a computer readable medium comprising:
means for instructing a computer to read out activity statistic data of an object group of people from a database storing activity statistics data made by consolidating activity patterns of people; and
means for instructing the computer to modify the readout activity statistic data in accordance with a constrained condition of place keyed in according to the object group to determine an activity occurrence probability of the object group.

18. The program according to claim 17, wherein the means for instructing the computer to modify the readout activity statistic data includes means for instructing to modify the readout activity statistic data according to constrained condition of place which is keyed in according to the object group.

19. The program according to claim 17, which further comprises means for instructing the computer to read out consumption expenditure data of the object group from a consumption expenditure database, and wherein the means for instructing the computer to modify the readout activity statistic data includes means for instructing the computer to modify the activity statistic data using the consumption expenditure.

20. The program according to claim 17, wherein the modifying includes modifying the activity statistic data by using preference data of the object group.

21. The program according to claim 17, further comprising means for instructing the computer to calculate a total of saved times for number of people in the group which are acquired by modifying activities of the object group, and allocating the total of saved times to the activities in accordance with the activity occurrence probability.
